(19) United States
(12) Patent Application Publication
(10) Pub. No.: US 2010/0200340 A1
(43) Pub. Date: Aug. 12, 2010

(54) BRAKING DEVICE FOR A RIMMED WHEEL, ESPECIALLY FOR A BIKE WHEEL

(75) Inventor: Guy Valembois, Toulouse (FR)

Correspondence Address: YOUNG & THOMPSON, 209 Madison Street, Suite 500, Alexandria, VA, 22314, US

(73) Assignee: TIME SPORT INTERNATIONAL, Vaulx Milieu (FR)

(21) Appl. No.: 12/446,103

(22) PCT Filed: Jul. 17, 2007
(86) PCT No.: PCT/FR07/01230

§ 371 Date: Apr. 17, 2009

(30) Foreign Application Priority Data
Jul. 17, 2006 (FR) 06 52996

(51) Int. Cl. B62L 1/14; B62L 3/02; B62L 1/16

(52) U.S. Cl. 188/24.21

(57) ABSTRACT

A braking device is designed to be mounted on a bicycle frame C with at least one wheel R with a rim (10), including a fixed support (12), two rigid arms (14G, 14D) that can move relative to the fixed support (12), and two elastic return links (16G, 16D) that are integral with the fixed support (12). The device is characterized in that each arm (14G, 14D) includes a friction member (22G, 22D) that is provided to interact with the rim (10) at the level of its lower end (20G, 20D), and a finger (24G, 24D) at the level of its upper end (18G, 18D); and each arm (14G, 14D) is connected to the fixed support (12) by the elastic return link (16G, 16D) that is interposed between its two upper ends (18G, 18D) and lower ends (20G, 20D) and the fixed support (12).

This invention relates to a braking device for a rimmed wheel, more especially for a rimmed bike wheel.

In the domain of cycling, bicycles generally comprise two wheels mounted on a frame and driving means with a pedal and gear mechanism comprising at least one chain wheel, at least one driving gear wheel integral with the rear wheel, and a transmission chain between the chain wheel and the gearwheel, for the large majority.

Nevertheless, major progress has been made in the domain of cycling under the impetus especially of large international races and participating professionals.

In this sport, amateurs are equally very demanding and are on the lookout for high-performance equipment.

It is thus that frames have evolved greatly, and it is recognized that this is a very important aspect of the performance of a bicycle.

Actually, the quality of a frame is largely dictated by the efficiency and restoration of exertion.

One problem that necessarily links two paradoxical parameters must be solved:
stiffness to prevent deformations and thus the absorption of energy, and
weight that must be reduced in order not to have an adverse effect on the participant, especially when on a course of slopes, i.e., steep slopes.

It is thus that the applicant of this invention has come to use composite materials integrating carbon fibers and/or technical fibers for building frames.

The components mounted on these frames are very sophisticated both from the standpoint of the mechanisms and the materials comprising them.

It is thus that the brackets, the handlebars, the derailleurs and their controls have developed dramatically.

Conversely, there has been relatively little progress in the area of brakes, which are safety elements first of all, but also performance elements. Riders, especially in competition, but also well-informed amateurs, need braking devices with excellent performance levels in riding downhill, especially when atmospheric conditions are poor.

Progress has been made on the braking interface. Thus, the annular zone of the rim has been subjected to surface treatments such as ceramic coating, and the brake pads themselves are produced from materials suitable for braking in a progressive manner even in the presence of water, and these pads are capable of maintaining these performance levels even when the temperature rises dramatically.

The mechanism for applying the pressure of these pads to the rim remains essentially unchanged. This mechanism comprises:
a lever-type actuator that can be manipulated by the rider, and
a transmission of the actions exerted by the rider on the lever toward the braking means by cable or by any other means, including hydraulic fluid.

These known braking means use a pair of arms located on either side of the rim. Each arm is rotationally mounted on a pivot that is integral with the frame.

Two arrangements are then possible:
either one of the ends of the arm bears the pad, the other end is connected to the transmission, and the pivot is interposed between the two ends,
or one of the ends of the arm is mounted on the pivot, the other end is connected to the transmission, and the pad is interposed between the two ends.

The traction directions implemented by the transmission are adapted so that each pad is placed against the rim when the rider applies a force on the lever with a multiplier effect.

Each of the arms, moreover, comprises return means, for example in the form of a loop spring, generally interposed between the frame and the arm so as to return from the rim the arm and the pad that it bears after the rider has applied an action.

These arrangements of the prior art have the drawback of requiring a pivoting link that is subject to several drawbacks.

The friction of the arm on the pivot is increased all the more as there are particles that are expelled while riding that could be introduced between the pivot and the arm. This produces greater exertions for actuation.

Moreover, there is the presence of a spring; this is an auxiliary piece, an additional weight, a source of problems by its very presence. Since this spring has a return function, it is necessary for the rider to apply a first force for neutralizing this return force, to which a second force is added for braking. To be certain of efficient return of the arm bearing the pad and to overcome possible additional friction to the right of the pivot link that has been caused by mud, the return means, generally a spring, are oversized.

Therefore, the exertion of the rider to neutralize this force during braking is proportionately increased.

It should be noted that on a bicycle, the rider must hold onto the handlebars and act with one or more fingers on the lever even if it would be desirable for the rider to have to exert only a small force on the lever, corresponding more or less to a single force necessary to activate the braking while avoiding additional exertion due to the oversized return means. The precision of braking would only be better. It should be noted that there is no possibility of inserting braking assistance as in motor vehicles.

With regard to the approach that would consist in increasing the length of the arms, it must be moderated by the fact that the stroke necessary at the level of the lever increases. Also, instead of increasing the power, parasitic friction must be neutralized.

Another drawback of the pivot link also lies in possible defects of progressiveness during braking actions, especially if partial sticking of said pivot link occurs. This sticking is primarily due to the degradation of the surface materials and the progressive wear that it engenders, especially in friction zones.

This invention suggests a braking device that is progressive, lighter than the devices of the prior art, and that neutralizes the risks of sticking due to greater resistance to wear, to neutralization of friction at the level of the pivot link, and to the production of said device from composite material. The braking device according to the invention, moreover, offers possibilities of an aerodynamic profile and particularly aesthetic shapes. For this reason, the object of the invention is a braking device that is designed to be mounted on a bicycle frame with at least one rimmed wheel, comprising a fixed support, two rigid arms that can move relative to said fixed support, and two elastic return links that are integral with said fixed support; said device is characterized in that since each arm comprises a friction member that is provided to interact with said rim at the level of its lower end and a finger at the level of its upper end, each arm is connected to said fixed support by the elastic return link that is interposed between its two upper and lower ends and said fixed support.

The braking device on the rim according to this invention, especially for a bicycle wheel, is now described in detail according to one particular but not limiting embodiment.

This description is based on the attached drawings, including different figures that show:

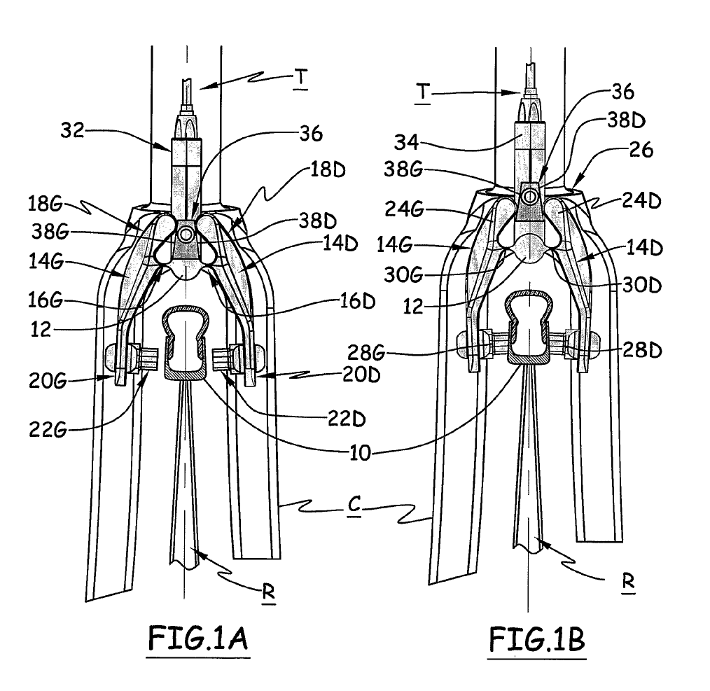

FIGS. 1A and 1B: a schematic view of a braking device according to the invention that equips a bicycle frame according to a first embodiment of handling means, in the rest position and in the braking position respectively,

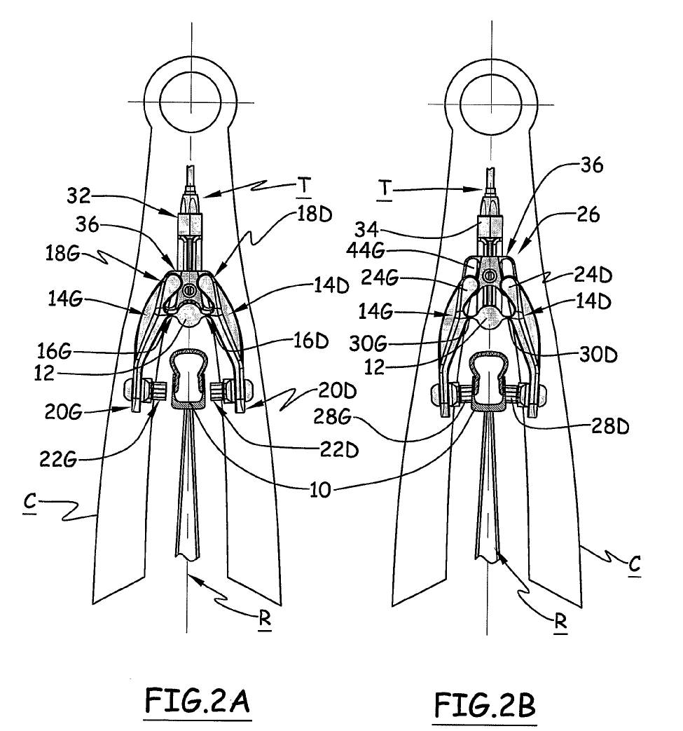

FIGS. 2A and 2B: a schematic view of a braking device according to the invention that equips a bicycle frame according to a second embodiment of handling means according to the invention, in the rest position and in the braking position respectively,

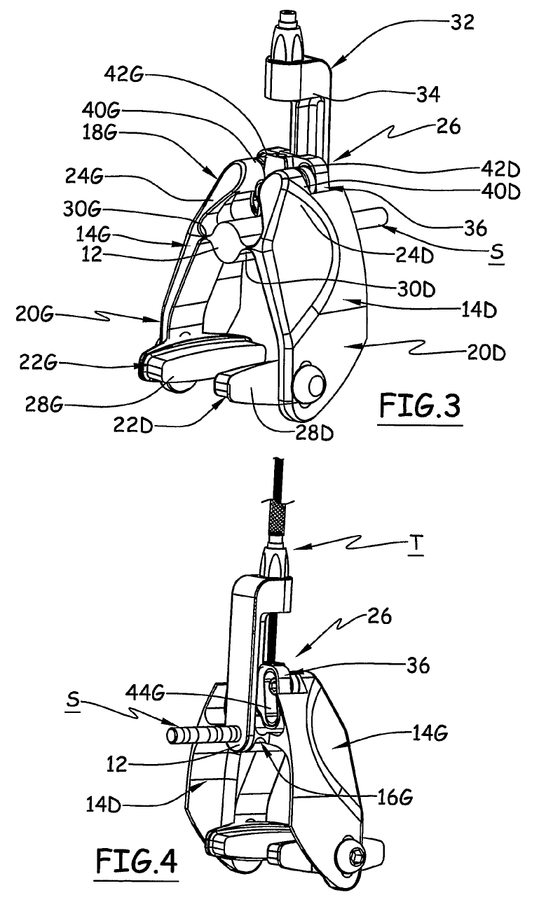

FIG. 3: a perspective front view of a braking device according to the invention in a second embodiment of the handling means in the rest position,

FIG. 4: a rear perspective view of a braking device according to the invention in a second embodiment of the handling means in the rest position.

FIGS. 1A, 1B, 2A, and 2B show a braking device according to the invention that is mounted on a bicycle frame C with at least one wheel R with a rim 10. FIGS. 1A and 1B illustrate one example of mounting a braking device on one part of a bicycle frame C that can be assimilated into a front fork, whereas FIGS. 2A and 2B illustrate one example of mounting a braking device on one part of a bicycle frame C that can be assimilated into rear braces.

The braking device can be mounted on any part of a bicycle frame C located in the vicinity of a wheel R with a rim 10, such as a front fork, rear braces or any other part of the bicycle frame.

The braking device according to the invention comprises a fixed support 12 that can be attached to a bicycle frame C, and two rigid arms 14G and 14D that can move relative to said fixed support 12 due to two elastic return links 16G and 16D that are integral with said fixed support 12.

In order to be connected to a bicycle frame C, said fixed support 12 comprises means of integration S with the frame C.

Each of the arms 14G or 14D is connected to the fixed support by a respective elastic return link 16G or 16D, a link 16G or 16D being interposed between the two upper ends 18G or 18D and lower ends 20G or 20D of an arm 14G or 14D and said fixed support 12.

Each elastic return link 16G or 16D allows movement of the arm that it supports between an initial position, i.e., rest position, and its active position, i.e., braking position.

The two arms 14G and 14D come in the form of two identical elements located essentially symmetrically on either side of the wheel R.

For each of the arms, the plane containing the arm 14G or 14D and the plane containing the connected elastic return link 16G or 16D are essentially perpendicular.

In order to implement braking, each arm 14G or 14D at the level of its lower end 20G or 20D comprises a friction member 22G or 22D that is designed to interact with the rim 10 as well as a finger 24G or 24D at the level of its upper end 18G or 18D.

The friction member 22G or 22D that allows braking comes in the form of a pad 28G or 28D attached to the lower end 20G or 20D of each arm 14G or 14D by any suitable means.

For example and as shown in the different figures, there is an oblong hole at the level of the lower end 20G or 20D of one arm in order to allow its alignment with the part of the rim 10 with which it must work as precisely as possible.

An arm 14G or 14D has a thickness e, a great width l and a height h between its upper end 18G or 18D and lower end 20G or 20D.

The great width l of the arm is designed to be positioned essentially in the plane of the bicycle so as to control the driving torque generated by the wheel R during braking. And the thickness e of the arm is suited to imparting sufficient rigidity to it during braking.

The arms 14G and 14D, just like the fixed support 12, are especially rigid, both in the plane of the bicycle and perpendicular to this plane, and more or less cannot be deformed on the scale of the forces applied.

As FIGS. 1A and 1B illustrate, the braking device according to the invention integrates handling means 26 that drive the movement of the arms 14G and 14D relative to the fixed support 12 especially due to the mobility of said arms allowed by the elastic return links 16G and 16D.

The fingers 24G and 24D of the arms 14G and 14D are part of the handling means 26 of the braking device according to the invention, and it is by putting them into motion, especially by said fingers 24G and 24D being moved apart, that these handling means 26 drive the movement of the arms 14G and 14D between their rest position and their braking position.

The rest position of said arms is illustrated in FIGS. 1A, 2A, 3 and 4, and their braking position is illustrated in FIGS. 1B and 2B.

These handling means 26, presented in detail below in the description, make it possible to generate the movement of each arm 14G and 14D from its rest position to its braking position, especially due to the exertion of the rider transmitted to said handling means 26 by suitable transmission means known to one skilled in the art, such as a brake lever connected to a sheath and a cable or any other means.

The return of the arm 14G or 14D from its braking position to its initial rest position is based entirely on the return force of the elastic return link 16G or 16D that connects it to the fixed support 12.

For this purpose, the elastic return links 16G and 16D that are interposed between the arms 14G and 14D and the fixed support 12 of the braking device according to the invention are links that work in bending.

In one preferred embodiment of the invention, the fixed support 12, the arms 14G and 14D as well as the elastic return links 16G and 16D are produced in a single piece of composite material, more especially carbon-based fibers, aramid fibers and/or glass fibers embedded in a resin matrix.

Thus, in a braking device made in a single piece in composite material, the fixed support 12 and the arms 14G and 14D can be produced based on fibers that promote rigidity and lightness, such as carbon fibers, whereas the links 16G and 16D, especially the webs 30G and 30D, can be produced based on fibers that promote elasticity, such as glass fibers.

As illustrated in FIGS. 3 and 4, the means of integration S with the frame C, especially a threaded axle, are also produced with said fixed support, said arms and said elastic return links.

The fixed support 12 and the arms 14G and 14D have geometries that are designed for adaptation to this mode of monolithic production of composite material and for mechanically withstanding the stresses generated during braking.

Also, each elastic return link 16G or 16D is composed of at least one web 30G or 30D that can be deformed by bending under the stress transmitted via the handling finger 24G or 24D and can allow the return into the initial rest position of the arm 14G or 14D as soon as said stress is relieved.

“Web” is defined as at least one zone that can be deformed by bending, proceeding from a defined neutral position, originating from production, under a stress that has arisen between the two pieces that it connects and that can assume its initial neutral position again when said stress is relieved.

Thus, the web 30G or 30D can be thick if the material comprising it makes it possible to achieve the desired result of working in bending.

Each elastic return link 16G or 16D is also produced so as to withstand the applied rotational torque R during braking.

The arrangement of the braking device according to the invention that is made in one monolithic piece of composite material is especially desirable because the web 30B or 30D makes it possible to transmit the rotational torque R that is applied by the wheel during braking and to which the arm 14G or 14D is exposed as far as the fixed support 12. Thus, the rotational torque is transmitted directly from the wheel/pad interface to the integration means S and is thus accommodated by the frame C.

The rider who is using this arrangement notices very high progressiveness during actions on the brake lever because all of the possible friction, mechanical sticking or binding points caused by the return springs of the devices of the prior art are neutralized.

The production of the elastic return link 16G or 16D from composite material also makes it possible to greatly lengthen the service life and the preservation of the efficiency of braking relative to the devices of the prior art comprising at least one pivot link and a spring that is returned by the arm.

Due to the braking device according to the invention, the elastic return force that is necessary to manipulate the arms 14G and 14D and to bring them back into the neutral position after a braking process is minimal, even if the exertion of the rider is not only progressive, but more or less integrally preserved for braking that allows very precise proportioning. This is all the more true as composite materials using high modulus fibers very faithfully transmit forces.

The progressiveness and the elastic return power can be easily adjusted by the profiles, the fibers, their diameters and/or their numbers, the orientations, and the nature of the resin comprising the matrix.

Such a braking device likewise yields an advantage that is inherent in its nature, but far from negligible in the domain of cycling: weight.

The different figures show in a simplified manner the transmission means T of the force applied by the rider to the integrated handling means 26 by a braking device according to the invention.

These transmission means T generally come in the shape of a sheath within which a cable revolves that is connected on one end to a brake lever, in the known manner, and on the other end to the handling means 26 of the braking device.

The braking device calls for means 32 for accommodating these control means, especially a stop 34 that is integral with the fixed support 12 and on which the sheath of the transmission means T will be supported.

According to a first embodiment illustrated in FIGS. 1A and 1B of these handling means 26 connected to the transmission means T, said handling means 26 comprise a corner 36 of essentially trapezoidal shape, the large base in the lower part, provided laterally with two guide surfaces 38G and 38D of the fingers 24G and 24D of two arms 14G and 14D, so that when traction is applied to said corner 36, it is translated vertically and causes the movement of the arms toward the braking position thereof.

More specifically, the vertical translation of the corner 36 causes the fingers 24G and 24D to move apart relative to one another, the relative movement of the arms 14G and 14D relative to the fixed support 12 due to the bending of the webs 30G and 30D, and thus the approach of the pads 28G and 28D to the rim 10.

According to a second embodiment, illustrated in FIGS. 2A, 2B, 3 and 4, of these handling means 26 connected to the transmission means T, each finger 24D or 24G of an arm 14D or 14G is equipped with a roller 40G or 40D mounted to rotate freely and said handling means 26 comprise a corner 36 of essentially trapezoidal shape provided laterally with two grooves 42G and 42D for rolling and guiding the rollers 40G and 40D such that when traction is applied to said corner 36, it is translated vertically, the rollers 40G and 40D roll in the grooves 42G and 42D and cause these rollers 40G and 40D to move apart, and the fingers 24G and 24D to which they are connected to move apart, the webs 30G and 30D to be bent, and thus the pads 28G and 28D to approach the rim.

More specifically, each of the fingers 24G or 24D is equipped with a roller 40G or 40D mounted to rotate freely.

One corner 36 is located in the middle part and laterally comprises two grooves 42G and 42D for rolling and guiding that can each accommodate the corresponding roller 40G or 40D.

This corner 36 is of essentially trapezoidal shape, the large base in the lower part.

In the rest position of the arms 14G and 14D of the braking device, the corner 36 is such that the rollers 40G and 40D are in the top part, to the right of the small base, FIGS. 2A, 3 and 4.

This corner 36 likewise bears means of attaching the active component of the transmission means T, in this case a cable.

With reference to FIGS. 2A, 2B, 3 and 4, a summary of operation can be presented.

When the rider applies a force to the brake lever that actuates the transmission means T, the cable that has been pulled relative to the sheath that is kept fixed by the stop 34 ensures traction on the corner 36 that is translated vertically.

Due to this movement, the rollers 40G and 40D, fixed in translation, roll in the corresponding grooves 42G and 42D of the corner 36 that is moved.

The width of the corner 36 increases, causing these rollers 40G and 40D to move apart, thus also the fingers 24G and 24D to which they are connected to move apart.

The fingers 24G and 24D cause bending of the webs 30G and 30D, the fixed support 12 remaining stationary.

The arms 14G and 14D, more especially their lower ends 20G and 20D, each bearing a pad 28G and 28D, approach one another and cause said pads 28 and 28D to be placed on the rim 10 of the wheel, then executing the desired braking.

According to a first development, the two guide surfaces 38G and 38D of a corner 36 or the two grooves 42G and 42D for rolling of a corner 36 can have curved profiles or variably inclined profiles. Thus, the corner 36 of the handling means 26 can allow the ratio (path of the finger of one arm)/(path of the brake pad) or the ratio (path of the brake lever)/(path of the finger of the arm) to vary. These variations of the ratio allow the behavior of the brake device to be influenced directly and therefore to be adapted to different riders.

According to a second development, the handling means 26 can integrate means of limitation of bending, especially to avoid exceeding the limit of acceptable bending, for example in the case of actuating the braking device after the wheel R has been removed, during maintenance.

Thus, as shown in FIGS. 2A, 2B, 3 and 4, the corner 36 can comprise two lights 44G and 44D that comprise the top and bottom stops of the corner, working with the screw heads protruding from the attachment of the rollers 40G and 40D.

This prevents any untimely bending beyond the elastic limit of bending of the elastic return links 16G and 16D, especially when the wheel R has been removed.

The braking device according to the invention yields advantageous characteristics of aerodynamics, compactness and lightness in the version produced in composite material.

The braking device according to its two embodiments can be marketed in the first tier but also in the second tier.

Adaptation is very simple since it is enough to attach the threaded rod of the means of integration S to the frame C in place of the existing device.

Finally, the braking device according to the invention yields major advantages in terms of weight, quality of braking, especially of flexibility and progressiveness, of resistance to wear, and even appearance.

1. Braking device that is designed to be mounted on a bicycle frame C with at least one wheel R with a rim (10), comprising a fixed support (12), two rigid arms (14G, 14D) that can move relative to said fixed support (12), and two elastic return links (16G, 16D) that are integral with said fixed support (12), characterized in that each arm (14G, 14D) comprises the following:
a finger (24G, 24D) at the level of its upper end (18G, 18D), and
a friction member (22G, 22D) that is designed to interact with said rim (10) at the level of
its lower end (20G, 20D),
each arm (14G, 14D) being connected to said fixed support (12) by an elastic return link (16G, 16D) interposed between its two upper ends (18G, 18D) and lower ends (20G, 20D) and said fixed support (12).

2. Braking device according to claim 1, wherein the elastic return link (16G, 16D) is a link that works with bending.

3. Braking device according to claim 1, wherein the elastic return link (16G, 16D) between the fixed support (12) and each arm (14G, 14D) is composed of at least one web (30G, 30D) that can be deformed by bending under the stress transmitted via each finger (24G, 24D) and can assume its initial rest position again as soon as said stress is relieved.

4. Braking device according to claim 1, wherein the fixed support (12), the arms (14G, 14D) and the elastic return links (16G, 16D) are produced in a single piece.

5. Braking device according to claim 1, wherein the fixed support (12), the arms (14G, 14D) and the elastic return links (16G, 16D) are produced in composite material.

6. Braking device according to claim 1, wherein it integrates the handling means (26) of the fingers (24G, 24D) comprising a corner (36) of essentially trapezoidal shape, the large base in the lower part, provided laterally with two guide surfaces (38G, 38D) of the fingers (24G, 24D) of two arms (14G, 14D), such that when traction is applied to this corner (26), it is translated vertically and causes said fingers (24G, 24D) to move apart.

7. Braking device according to claim 1, wherein each finger (24G, 24D) is equipped with a roller (40G, 40D) mounted to rotate freely and wherein it integrates handling means (26) of the fingers (24G, 24D) comprising a corner (36) of essentially trapezoidal shape, the large base in the lower part, provided laterally with two grooves (42G, 42D) for guiding the fingers (24G, 24D) of the two arms (14G, 14D), such that when traction is applied to the corner, it is translated vertically and causes said fingers (24G, 24D) to move apart.

8. Braking device according to claim 6, wherein the corner (36) comprises the top and bottom stops so as to prevent any untimely bending beyond the elastic limit of bending of the elastic return links (16G, 16D).

9. Braking device according to claim 2, wherein the elastic return link (16G, 16D) between the fixed support (12) and each arm (14G, 14D) is composed of at least one web (30G, 30D) that can be deformed by bending under the stress transmitted via each finger (24G, 24D) and can assume its initial rest position again as soon as said stress is relieved.

10. Braking device according to claim 2, wherein the fixed support (12), the arms (14G, 14D) and the elastic return links (16G, 16D) are produced in a single piece.

11. Braking device according to claim 2, wherein the fixed support (12), the arms (14G, 14D) and the elastic return links (16G, 16D) are produced in composite material.

12. Braking device according to claim 2, wherein it integrates the handling means (26) of the fingers (24G, 24D) comprising a corner (36) of essentially trapezoidal shape, the large base in the lower part, provided laterally with two guide surfaces (38G, 38D) of the fingers (24G, 24D) of two arms (14G, 14D), such that when traction is applied to this corner (26), it is translated vertically and causes said fingers (24G, 24D) to move apart.

13. Braking device according to claim 2, wherein each finger (24G, 24D) is equipped with a roller (40G, 40D) mounted to rotate freely and wherein it integrates handling means (26) of the fingers (24G, 24D) comprising a corner (36) of essentially trapezoidal shape, the large base in the lower part, provided laterally with two grooves (42G, 42D) for guiding the fingers (24G, 24D) of the two arms (14G, 14D), such that when traction is applied to the corner, it is translated vertically and causes said fingers (24G, 24D) to move apart.

14. Braking device according to claim 7, wherein the corner (36) comprises the top and bottom stops so as to prevent any untimely bending beyond the elastic limit of bending of the elastic return links (16G, 16D).
